(19) United States
(12) Patent Application Publication
(10) Pub. No.: US 2010/0186553 A1
(43) Pub. Date: Jul. 29, 2010

(54) Bottle Cap Remover

(76) Inventor: Bob Seastrom, Twin Falls, ID (US)

Correspondence Address: GREENBERG & LIEBERMAN, LLC, 2141 WISCONSIN AVE, N.W., SUITE C-2, WASHINGTON, DC, 20007, US

(21) Appl. No.: 12/066,195

(22) PCT Filed: Sep. 7, 2006
(86) PCT No.: PCT/US2006/034898

§ 371 Date: Apr. 8, 2010

Related U.S. Application Data
(60) Provisional application No. 60/596,181, filed on Sep. 7, 2005.

(51) Int. Cl. B67B 7/18

(52) U.S. Cl. 81/3.2; 81/3.4

(57) ABSTRACT

An air powered bottle cap remover that can rotate at a slower speed than a conventional air powered wrench tip. The present invention rotates conventionally via air from an air powered tool such as that typically found in an auto garage. One end of the present invention is sized to fit a conventional air power tool, while the other end of the present invention is sized and shaped to receive a conventional bottle cap, such as a crown bottle cap. A rubber insert prevents noise and abrasion from the present invention rubbing atop a bottle cap being removed.

### CONTINUITY DATA

This application claims priority to and is a non-provisional application of provisional patent application No. 60/596181 filed on Sep. 7, 2005.

### FIELD OF THE INVENTION

The present invention relates to removing bottle caps, and more particularly, concerns a device for employing air power to open bottle caps.

### BACKGROUND OF THE INVENTION

There are various ways to secure a beverage in a bottle, and one of the most popular methods is via a bottle cap. Bottle caps ensure that liquid inside bottles remain isolated from the outside elements. However, there is always a balance that must be achieved when securing a bottle cap to a bottle. On the one hand, the bottler wants to prevent the liquid from leaking from the bottle and wants to avoid contamination of the liquid in the bottle. On the other hand, the bottler wants to allow users easy access to the liquid inside the bottle.

A crown bottle cap is often secured to a ridge on the neck of a bottle. The crown bottle cap has crimps around its bottom circumference. To remove, the user must bend the bottle cap away from the ridge so that there is no longer a seal. To open such crown bottle caps, users are faced with pressing the edge of the bottle cap against a hard edge such as a table top so that the bottle cap bends. Bottle openers have been developed that provide a first finger-like projection that can be biased underneath an edge of the bottle cap while a second finger-like projection presses down upon the top of the bottle cap. The bottle cap opener is shifted so that the second finger-like projection increases pressure atop the bottle cap while the first finger-like projection pulls the bottle cap edge away from the bottle beck. Care has to be taken when using any method to remove a crown bottle cap secured to a ridge on the neck of a bottle, as pressure that is too severe can easily cause the neck of the bottle to break rather than bending the bottle cap. Obviously, injury can occur if the bottle neck breaks, but additionally, liquid in the bottle is oftentimes spilled.

Thus, there is a need for a safe device and/or method for removing crown bottle caps from bottles. Such a device would need to have enough force to remove a crown bottle cap. Additionally, such a device and/or method would need to be delicate enough so as to prevent breaking the neck of the bottle. Moreover, such a device would need to be relatively socially acceptably quiet else no one would use it in any social gathering.

Currently, twist bottle caps are rather popular on beers and other liquids held in bottles. Twist bottle caps are most often crown bottle caps as well, but twist bottle caps are not secured to a ridge on the neck of a bottle, although twist bottle caps do have crimps along their bottom circumference. The twist bottle cap is threaded on top of a conventional bottle, the bottle having a neck with a threaded top end. The twist bottle cap, upon application to the bottle, is tightened sufficiently upon the threads of the bottle's neck so that the user must exert a certain degree of force to begin to twist the twist bottle cap for removal. Herein lies a problem, in that the user does not want to apply too much force in twisting, or the user risks actually breaking the neck of the bottle. Further, the twist bottle caps are typically rather small, such that a small surface area for gripping the twist bottle cap is presented to the user. Any users, but especially those users with big hands, oftentimes find grasping a twist bottle cap difficult. Moreover, twist bottle caps frequently have sharp bottom edges that can injure a user—the crimps referred to above. Users typically will press and twist on the sharp bottom edges inadvertently or simply because there is a lack of surface area on the twist bottle cap so pressure must be applied.

Thus, there is a need for a device and/or method that can easily turn a twist bottle cap while preventing any possible injury to the user. Further, there is a need for a device and/or method that is capable of turning a twist bottle cap even though a typical twist bottle cap has a relatively small surface area. Also, there is a need for a device and/or method that can turn a twist bottle cap without danger of breaking the neck of the bottle to which the twist bottle cap is fastened.

### SUMMARY OF THE INVENTION

The present invention is a bottle cap remover that can work with either crown bottle caps that are twist bottle caps or crown bottle caps secured to a ridge on the neck of a bottle. The present invention is an air powered cap remover, the design modified from that of an automotive lug nut wrench. The socket that normally would fit a lug nut has been redesigned to fit a bottle cap. A conventional bottle cap is inserted into the socket and is twisted off a bottle. The air release hole in the redesigned socket can be smaller than the tip of a conventional automotive lug nut socket. The speed of rotation of the redesigned socket can be made slower than the speed of rotation that would normally exist for a conventional lug nut socket in such a way. If the present invention has a slower speed of rotation, the present invention can be safely fitted to a bottle cap and can twist safely to remove the bottle cap without causing the neck of a bottle below the bottle cap to break. Further, even the present invention does not have a slower speed or rotation, it will work. The present invention can be rotated clockwise or counterclockwise to remove a bottle cap. If a twist off bottle cap, the present invention will not break the neck of the bottle, but will merely just turn the cap around and around unless cap is turned in the direction to unthread it.

### BRIEF DESCRIPTION OF THE FIGURES

FIG. 1 shows an environmental view of the present invention.

### DETAILED DESCRIPTION OF THE PREFERRED EMBODIMENT(S)

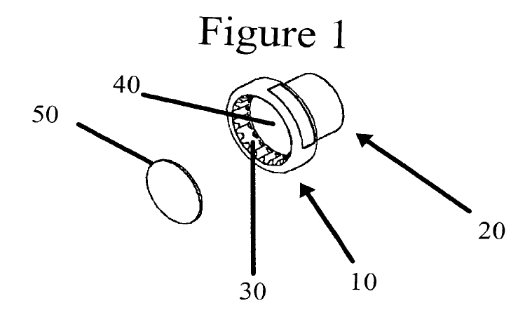

As shown in FIG. 1, first end 10 is shaped to receive a conventional crown bottle cap. Second end 20 is a conventional end of a socket fitting into a power tool, such as a pneumatic power tool. Ridges 30 are disposed around the inside circumference of first end 10 such that they are positioned to communicated between the ridges of a conventional bottle cap inserted therein. Between the ridges 30 of first end 10 and second end 20 is a flat area 40 which is shaped flat in a circular configuration to allow the top a received conventional bottle cap to rest thereon. Because a conventional bottle cap is typically made of metal, and the top of a conventional bottle cap placed into first end 10 will press up against flat area 40, the present invention provides insert 50 to sit on top of flat area 40. Insert 50 is preferably a rubber insert which prevents the top of a conventional bottle cap from contacting flat area 40. Insert 50 thus prevents the metal of a conventional bottle cap from rubbing against flat area 40. The present invention can be rotated more slowly by channeling air through it at a lower pressure or opening and/or enlarging a conventional release valve on the pneumatic tool.

Aside from that which has been described, the rest of the present invention is a conventional socket adaptation, similar to a socket wrench, that would fit into a power tool such as a pneumatic tool.

The present invention is not solely limited to embodiments above, but is all of the embodiments within the scope of the following claims.

I claim:

1. A bottle cap remover, comprising:
a first end adapted to receive a bottle cap; and
a second end, opposite said first end, adapted to be fitted into an air driven power device.

2. The bottle cap remover of claim 1, wherein said first end has ridges corresponding to the ridges around the circumference of a conventional bottle cap.

3. The bottle cap remover of claim 1, wherein said first end has ridges around its circumference.

4. The bottle cap remover of claim 1, wherein said first end has ridges designed to fit between the ridges of a conventional bottle cap.

5. The bottle cap remover of claim 1, further comprising an insert in said first end.

6. The bottle cap remover of claim 5, wherein said insert is rubber.

7. The bottle cap remover of claim 2, further comprising an insert in said first end, said insert positioned between said ridges and said second end.

8. The bottle cap remover of claim 1, further comprising a rotation slowing means in communication with said first end and said second end.

9. The bottle cap remover of claim 7, wherein said first end has ridges around its circumference.

10. The bottle cap remover of claim 9, wherein said ridges are at the bottom end of said first end, said bottom end being most opposite of said second end.
